(19) United States
(12) Patent Application Publication
(10) Pub. No.: US 2008/0296992 A1
(43) Pub. Date: Dec. 4, 2008

(54) Electrical Drive Machine

(76) Inventor: Michael Militzer, Homberg/Ohm (DE)

Correspondence Address: Walter A Hackler;Patent Law Office, 2372 S E Bristol Street, Suite B, Newport Beach, CA, 92660-0755, US

(21) Appl. No.: 11/992,449

(22) PCT Filed: Sep. 5, 2006
(86) PCT No.: PCT/EP2006/008634

§ 371 Date: Aug. 6, 2008

(30) Foreign Application Priority Data
Sep. 23, 2005 (DE) 10 2005 045 503.4

(51) Int. Cl. H02K 1/06; H02K 21/12

(52) U.S. Cl. 310/179; 310/156.01

(57) ABSTRACT

A three-phase electrical drive machine is described, comprising a static primary part (2) having a sequence of stator grooves (3), in which stator windings (4) of the three phases (U, V, W) are positioned in such a manner that an electric current through the stator windings (4) generates primary part magnetic poles, and a secondary part (5), which is movable on a predefined movement path in relation to the primary part (2) and on which permanent magnets (6) are positioned in such a manner that one of each of their poles faces toward the primary part (2), resulting in a sequence of secondary part magnetic poles in the movement direction, a movement of the secondary part (5) on the movement path being caused by interaction of the primary part magnetic poles, which result from the flow of current, with the secondary part magnetic poles. According to the invention, the ratio of the number of the secondary part magnetic poles facing toward the primary part (2) to the number of the primary part magnetic poles lying, in a given position of the secondary part (5), opposite to them is 19:12.

The invention relates to a three-phase electrical drive machine comprising a static primary part having a sequence of stator grooves, in which stator windings of the three phases are positioned in such a manner that an electric current through the stator windings generates primary part magnetic poles, and a secondary part, which is movable on a predefined movement path in relation to the primary part and on which permanent magnets are positioned in such a manner that one of their poles faces toward the primary part, forming a sequence of secondary part magnetic poles in the movement direction. A movement of the secondary part on the movement path is caused by interaction of the primary part magnetic poles, resulting from the flow of current, with the secondary part magnetic poles.

Drive machines of this type have been known for some time. Rotary drive machines having these features include in particular rotating field motors having permanent magnetization. The invention relates in particular to drives for elevators and other applications in which similar requirements exist as for elevators. For drives of this type, vibratory forces and load pulsation torques have been a problem for some time. These result in performance losses and annoying noise development. Known noise sources of this kind are in particular current-independent effects and cogging torques as well as current-dependent phenomena, which result in unbalanced radial and tangential forces in the machine.

Various measures are known in the prior art to achieve more uniform force action and minimize the noise development. For example, the stator windings may be positioned overlapping in more than two stator grooves as so-called distributed windings. Turns of different stator windings are wound around stator teeth between the individual stator grooves. However, this results in a higher overall electrical resistance and thus a reduced efficiency of the drive machine.

Furthermore it is known to minimize vibration forces and load pulsation torques by using molded magnets, for example shell-shaped or trapezoidal magnets, as the permanent magnets. In addition, a rotor is used as the secondary part in drive machines according to the prior art, in which the permanent magnets are positioned in magnet rows which do not run parallel to its axis, but rather are oriented diagonally at a small angle of a few degrees to the axial direction of the rotor.

### SUMMARY OF THE INVENTION

Compensation of vibration forces and load pulsation torques may be achieved and the noise development may be reduced by these measures, but they are connected with significant performance losses and significantly increased production costs, in particular if molded magnets are used.

An object of the invention is therefore to disclose a better way in which vibration forces, load pulsation torques, and noise sources connected thereto may be minimized with lower performance losses in an electrical drive machine of the type described at the beginning.

This object is achieved according to the invention in that the ratio of the number of the secondary part magnetic poles facing toward the primary part to the number of primary part magnetic poles which, in a given position of the secondary part, is located opposite thereto is 19:12.

In the context of the invention, it has been established that this ratio is optimal in regard to performance and compensation of noise sources, in particular vibration forces and load pulsation torques. In a drive machine according to the invention, vibration forces and load pulsation torques may be largely avoided, so that lower-noise operation is possible even without the use of expensive molded magnets and the advantages of lower production costs and lower performance losses may be combined. This is all the more surprising because heretofore it was assumed in the literature that it is favorable to select the number of the secondary part magnetic poles and the number of the primary part magnetic poles in such a manner that they differ only slightly, in particular by only one or two.

In the context of the invention it has been established that the specified ratio is not only optimal for drive machines in which the secondary part is a rotor, but rather also results in improved results in linear drives. In a linear drive, of course, the number of windings of the static primary part and as a result the number of the primary part magnetic poles are, in principle, unlimited and are essentially only determined by the maximum displacement path of the movable secondary part. In a given position of the secondary part, however, always only a partial set of the total number of primary part magnetic poles lies opposite to the secondary part magnetic poles. The specified ratio of 19:12 relates only to those primary part magnetic poles which are opposite to the secondary part in a given position thereof, and which are therefore active in the force development of the electrical machine.

A low-noise drive machine having low performance losses of the type described at the beginning may also be achieved in that at least two stator windings of at least one phase have opposite winding directions. A machine of this type represents a further aspect of the invention, which has independent significance for an arbitrary number of primary part and secondary part magnetic poles.

### BRIEF DESCRIPTION OF THE DRAWINGS

Further details and advantages of the invention are explained in greater detail on the basis of an exemplary embodiment with reference to the attached figures. The features described therein may be used individually or in combination to provide preferred embodiments. In the figures

FIG. 1 shows an exemplary embodiment of a drive machine according to the invention in cross-section (without stator windings);

FIG. 2 shows the electrical interconnection of the stator windings of the exemplary embodiment shown in FIG. 1.

FIG. 3 shows a stator tooth of the exemplary embodiment shown in FIG. 1.

### DETAILED DESCRIPTION

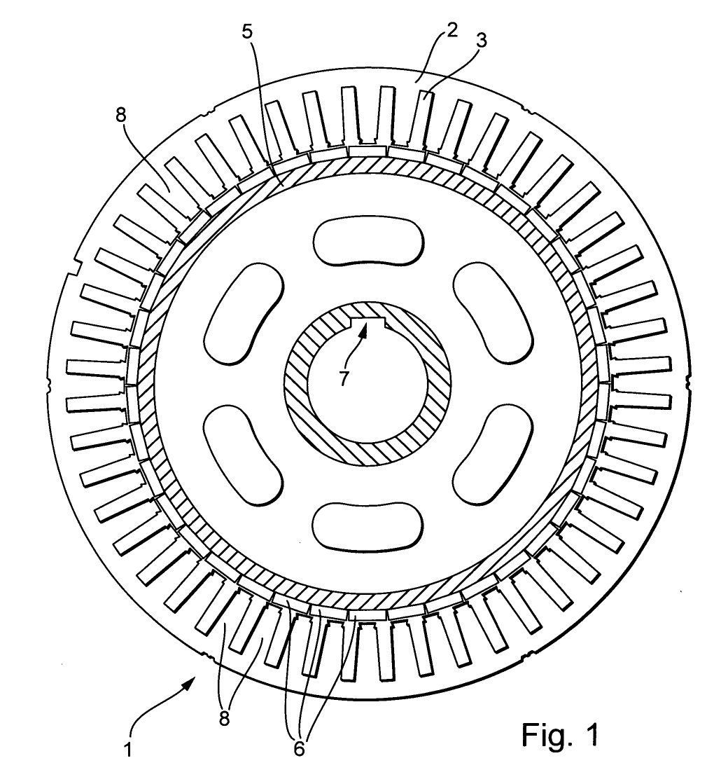

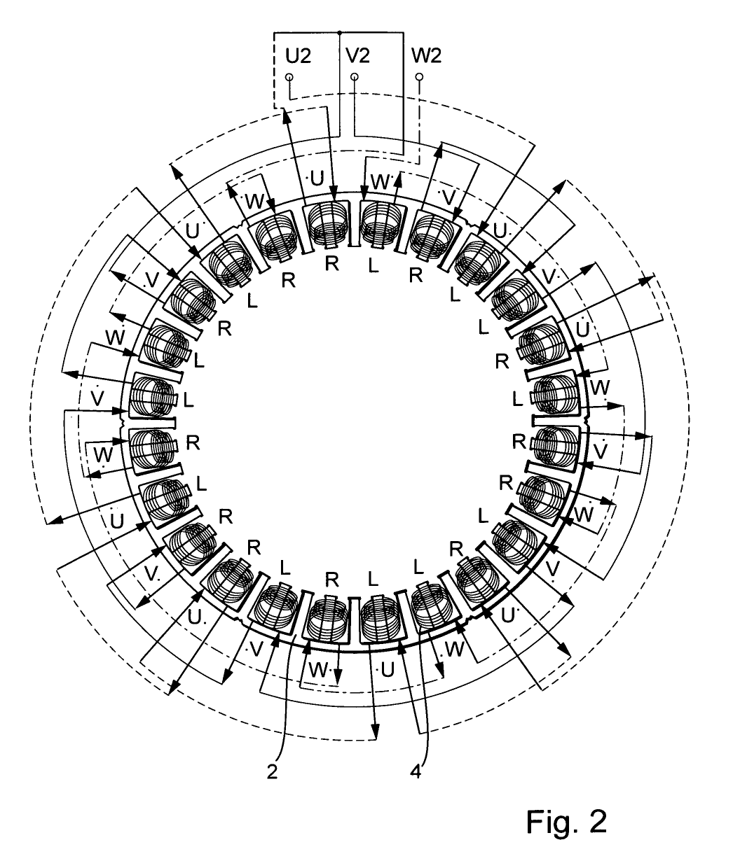

FIG. 1 shows, as an exemplary embodiment of an electrical drive machine 1, a synchronous machine which, for simplification, is shown without stator windings. The stator windings 4 and their electrical interconnection are shown in FIG. 2. The drive machine 1 comprises a static primary part 2 having a sequence of 48 stator grooves 3. As FIG. 2 shows, stator windings 4 of the three phases U, V, W are positioned as concentric windings in the stator grooves 3. This means that essentially all turns of a winding 4 are wound around a single stator tooth 8 and neighboring windings 4 do not overlap. All turns of a given winding 4 are preferably wound around a single stator tooth 8. However, practically no differences result in regard to the generated magnetic fields if some turns of a stator winding 4, for example, three of 100, are wound around a second stator tooth 8, which carries a neighboring winding 4, so that cases of this type may also be understood as concentrated windings.

The individual windings 4 of the phase U are each connected in series and form a winding phase. The windings 4 of the phases V, W are also each connected in series in a corresponding way. The lines of the phases U, V, W are shown as circles around the primary part 2. For clarification, in FIG. 2 the assignment of the individual windings 4 to the phases U, V, W is additionally identified by the corresponding letters. Lines of the phase U are shown by dashed lines on the outermost circle. Lines of the phase V are shown by solid lines on a middle circle and lines of the phase W are shown by dot-dashed lines on the innermost circle. However, it is also possible to connect some or all windings 4 of a phase U, V, W in parallel.

The illustrated drive machine is an internal-rotor machine. The primary part 2 encloses a secondary part 5, implemented as a rotor, which is movable on a predefined movement path, namely rotating around the common axis of parts 2 and 5, in relation to the primary part 2. Permanent magnets 6, shaped as rectangular parallelepipeds, are positioned on the secondary part 5 in such a manner that one pole of each of the permanent magnets 6 faces toward the primary part 2. The permanent magnets 6 are thus magnetized radially in relation to the rotational axis. This results in an alternating sequence of secondary part magnetic poles in the movement direction. A movement of the secondary part 5, namely a rotation, on the movement path is caused by interaction of the primary part magnetic poles, which result from a flow of current through the stator windings 4, with the secondary part magnetic poles. A torque is generated thereby, which is transmitted by the secondary part 5 to a shaft, which engages by means of a tongue in a groove 7 of the secondary part 5.

In the illustrated exemplary embodiment, the permanent magnets 6 are positioned on the secondary part 5 aligned in magnet rows which run in its axial direction. The ratio of the number of the secondary part magnetic poles facing toward the primary part 2, to the number of the primary part magnetic poles opposite to them, is 19:12 in the illustrated exemplary embodiment. Internal-rotor synchronous machines in which 24 primary part magnetic poles lie opposite to each 38 secondary part magnetic poles facing toward the primary part 2 are especially high performance and low noise. In the synchronous machine 1 illustrated in FIG. 2, a total of 24 stator windings 4, i.e., 24 primary part magnetic poles, lie opposite a total of 38 secondary part magnetic poles.

It is important in this context that the number of the primary part magnetic poles does typically correspond to the number of the magnet rows (i.e., the number of permanent magnets 6 positioned in one cross-sectional plane, as shown in FIG. 1), but this does not necessarily have to be the case. If neighboring magnet rows each have an opposing magnetization direction, as in the illustrated exemplary embodiment, the number of the magnetic poles corresponds to the number of the magnet rows. However, the same result may be achieved with respect to the geometry of the generated magnetic field if, for example, twice as many magnet rows are used, which are each only half as wide, two neighboring magnet rows each forming one magnetic pole, i.e., both having their north pole oriented radially outward or both having their north pole oriented radially inward. Therefore the operation is not a function of the number of magnets, but rather of the number of magnetic poles formed thereby facing toward the particular other part.

To minimize vibration forces and load pulsation torques, it is favorable if at least two stator windings 4 of at least one phase have opposite winding directions. The winding direction of the stator windings 4 is identified in FIG. 2 by the letters L or R. Half of the stator windings 4 of a phase have a first winding direction L and the other half have an opposite winding direction R. This means half of the stator windings 4 are wound clockwise and the other half are wound counterclockwise.

FIG. 2 also shows that around the circumference between each two stator windings 4 of a given phase, such as the phase U, at least one stator winding 4 of another phase, such as the phase V or W, is positioned. Each two stator windings 4 of a phase form a winding pair.

The two stator windings 4 of a winding pair each have an opposite winding direction and exactly one stator winding 4 of another phase is positioned between them. In this manner, performance losses may be reduced to a minimum and vibration forces may also be minimized especially well.

In the illustrated exemplary embodiment, one stator winding 4 occupies two adjacent stator grooves 3 in each case. Between each of the individual stator grooves 3 a stator tooth 8 is positioned. This means that a stator winding 4 is wound around every second stator tooth 8. This geometry is advantageous both for manufacturing and also with respect to the resulting magnetic flux path. It is, however, also possible, in principle to wind a stator winding 4 around each stator tooth 8, so that the number of the stator grooves 3 corresponds to the number of the stator windings 4.

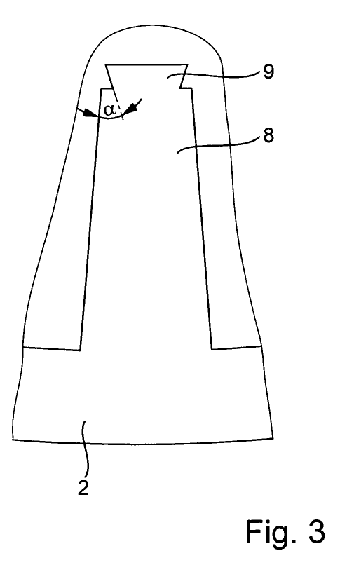

Furthermore, it is favorable for an optimal guiding of the magnetic flux, if the stator teeth 8 carry a head 9 on their free end, whose width is greater on its end facing toward the secondary part 2 than it is on its end facing toward the primary part 5. A stator tooth 8 of the drive machine 1 shown in FIG. 1 is illustrated in FIG. 3. The head 9 is seated on an essentially trapezoidal tooth 8, which tapers outwardly toward its free end. The head 9 is itself also trapezoidal. It is especially favorable if the lateral faces of the head 9 run at an angle α of 20 to 30°, preferably 24 to 26°, to the neighboring lateral face of the tooth 8.

The described drive machine is an internal-rotor synchronous machine, which is suitable in particular for elevators and is an especially important application of the invention. As already noted, numerous variants of the teaching of the invention are possible. In particular it can also be used in linear drives as well as in external-rotor rotation motors.

The total number of the permanent magnets and electrical windings used in an electrical drive machine according to the invention may vary to a large extent, for example because of the following reasons:
A plurality of neighboring permanent magnets jointly form one secondary part magnetic pole facing toward the primary part and/or windings jointly form one primary part magnetic pole facing toward the secondary part.
In the case of a rotation machine (electric motor), the primary part (stator) and the secondary part (rotor) have integral multiples of 24 or 38 (active) magnetic poles, respectively, facing toward the particular other part on their circumference.
A plurality of magnetic poles, each facing toward the other part, are positioned in a row in the direction transverse to the predefined movement path of the secondary part.

In any case, it is advantageous if the ratio of the magnetic poles of the two parts facing toward one another, whose interaction causes the drive, is in the specified ratio. Their spacing in the movement direction is then in the reverse ratio.

What is claimed is:

1. Three-phase electrical drive machine comprising
a static primary part (2) having a sequence of stator grooves (3), in which stator windings (4) of the three phases (U, V, W) are positioned, so that a current flowing through the stator windings (4) generates primary part magnetic poles, and
a secondary part (5), which is movable on a predefined movement path in relation to the primary part (6) and on which permanent magnets (6) are positioned in such a manner that one of their poles faces toward the primary part (2) resulting in a sequence of secondary part magnetic poles in the movement direction,
wherein a movement of the secondary part (5) on the movement path is caused by interaction of the primary part magnetic poles, which result from the flow of current, with the secondary part magnetic poles,
characterized in that
the ratio of the number of the secondary part magnetic poles facing toward the primary part (2) to the number of the primary part magnetic poles opposite thereto in a given position of the secondary part (5) is 19:12.

2. Drive machine according to the preamble of claim 1, characterized in that at least two stator windings (4) of at least one phase (U, V, W) have opposite winding directions (L, R).

3. Drive machine according to claim 2, characterized in that in all three phases (U, V, W), at least two stator windings (4) have opposite winding directions (R, L).

4. Drive machine according to claim 2, characterized in that one half of the stator windings (4) of a phase (U, V, W) have a first winding direction (R, L) and the other half have an opposite winding direction (L, R).

5. Drive machine according to claim 1, characterized in that at least one stator winding (4) of another phase (U, V, W) is positioned between each two stator windings (4) of a given phase (U, V, W) around the circumference.

6. Drive machine according to claim 5, characterized in that two stator windings (4) of a phase (U, V, W) form a winding pair, wherein the two stator windings (4) of a winding pair each have an opposite winding direction (R, L) and exactly one stator winding (4) of another phase (U, V, W) is positioned between them.

7. Drive machine according to claim 1, characterized in that the secondary part (5) is a rotor, and 24 primary part magnetic poles lie opposite to 38 secondary part magnetic poles each facing toward the primary part.

8. Drive machine according to claim 1, characterized in that stator teeth (8) are positioned between the stator grooves (3), which have a head (9) on their free end, the width of the head on its end facing the secondary part (5) being wider than on its end facing toward the primary part (2).

9. Drive machine according to claim 8, characterized in that the head (9) has a trapezoidal cross section.

10. Drive machine according to claim 1, characterized in that the permanent magnets (6) are shaped as rectangular parallelepipeds.

11. Drive machine according to claim 1, characterized in that it is a synchronous machine.

12. Drive machine according to claim 1, characterized in that the stator windings (4) are implemented as concentrated windings.

13. Drive machine according to claim 1, characterized in that the primary part (2) surrounds the secondary part (5).

14. Use of the drive machine (1) according to claim 1 for an elevator.
